(19) United States
(12) Patent Application Publication
(10) Pub. No.: US 2011/0239196 A1
(43) Pub. Date: Sep. 29, 2011

(54) Micro-Task Pipeline Visualization

(76) Inventor: Laurent Ichard, Cagnes sur Mer (FR)

(21) Appl. No.: 12/757,999

(22) Filed: Apr. 10, 2010

(30) Foreign Application Priority Data
Mar. 29, 2010 (EP) 10 290 163.4

(51) Int. Cl. G06F 11/36

(52) U.S. Cl. 717/127

(57) ABSTRACT

A digital system is described that includes a plurality of interconnected functional modules each having one or more event signal outputs, wherein each module is configured to execute one or more tasks and to assert an event signal on its respective one or more event signal outputs to indicate progress of execution of a task. An event monitor is connected to receive from each of the plurality of functional modules the one or more event signal lines, wherein the event monitor is configured to record the occurrence of each event signal assertion. An interface module is coupled to the event monitor and has an output for transferring an indication of each event signal assertion to an external monitoring system.

### CLAIM OF PRIORITY

This application for patent claims priority to European Patent Application No. EP 10 290 163.4 (Attorney docket TI-68551EP-PS) entitled “Micro-Task Pipeline Visualization” filed 29 Mar. 2010, and is incorporated by reference herein.

### FIELD OF THE INVENTION

This invention generally relates to application software development, software integration, and system optimization of complex integrated circuits and in particular to tracing events indicative of execution of micro-tasks.

### BACKGROUND OF THE INVENTION

Testing and debugging of a new application specific integrated circuit (ASIC) or of a new or modified application program running on an ASIC requires insight into the internal workings of busses and program execution. The IEEE 1149.1 (JTAG) standard has proven to be a very robust solution to a variety of test and debug systems, enabling a rich ecosystem of compliant products to evolve across virtually the entire electronics industry. Yet increasing chip integration and rising focus on power management has created new challenges that were not considered when the standard was originally developed. The Mobile Industry Processor Interface (MIPI) Test and Debug Working group has selected a new test and debug interface, called P1149.7, which builds upon the IEEE1149.1 standard. P1149.7 enables critical advancements in test and debug functionality while maintaining compatibility with IEEE 1149.1. In addition to P1149.7, the MIPI test and debug interface specifies how multiple on-chip test access port (TAP) controllers can be chained in a true IEEE1149.1 compliant way. It also specifies a System Trace Module (STM). STM consists of a System Trace Protocol (STP) and the Parallel Trace Interface (PTI). The signals and pins required for these interfaces are given through the ‘MIPI Alliance Recommendation for Test & Debug—Debug Connector’, also part of the MIPI test and debug interface. The main blocks of the MIPI Debug and Trace Interface (DTI), seen from outside of the system, include: a debug connector; the basic debug access mechanism: JTAG and/or P1149.7; a mechanism to select different TAP controllers in a system (Multiple TAP control); and a System Trace Module.

The System Trace Module helps in software debugging by collecting software debug and trace data from internal ASIC buses, encapsulating the data, and sending it out to an external trace device using a minimum number of pins. STM supports the following features:
Highly optimized for SW generated traces
Automatic time stamping of messages
Allows simultaneous tracing of 255 threads without interrupt disabling
Configurable export width 1/2/4 pin+dedicated clock+optional return channel
   Minimal pin usage 2 pin (1 data+1 clock)
   Maximum pin usage 6 pins (4 data+1 clock+1 return channel)
Maximum planned operating frequencies 166 MHz (double data rate clocking)
Provides a maximum bandwidth of slightly above 1 Gbit/s (theoretical max. 1.6 Gbit/s)
Supports up to 255 HW trace sources
Support for 8, 16, 32 and 64 bit data types

A maximum of 255 different bus initiators can be connected to the STM trace port via a bus arbiter. The bus initiators can be configured for either SW or HW type to optimize the system for different types of trace data. SW type initiator messages are used to transmit trace data from operating system (OS) processes/tasks on 256 different channels. The different channels can be used to logically group different types of data so that it is easy to filter out the data irrelevant to the ongoing debugging task. The message structures in STM are highly optimized to provide an efficient transport especially for SW type initiator data.

### BRIEF DESCRIPTION OF THE DRAWINGS

Particular embodiments in accordance with the invention will now be described, by way of example only, and with reference to the accompanying drawings:

FIG. 1 is a block diagram illustrating a exemplary system on a chip (SOC) with micro-task event monitoring circuitry coupled to a system trace module (STM);

FIG. 2 is a block diagram illustrating an exemplary node for use in the system of FIG. 1;

FIG. 3 is a time line illustrating triggering of event tracing;

FIG. 4 is a more detailed block diagram of the event trace module in FIG. 1;

FIG. 5 illustrates the general format of the STP message format;

FIG. 6 is a timing diagram illustrating a data stream conforming to STP format which includes a time stamp;

FIG. 7 is a flow chart illustrating operation of the event tracing logic of FIG. 1; and

FIG. 8 is a block diagram illustrating a system that includes an ASIC with an embodiment of an STM that includes a system event tracing module.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Embodiments of the present invention provide visibility into increasingly complex SOCs (system on a chip). Many SOC now include multiple processors, hardware accelerators, and/or other functional modules that may cooperate in a somewhat autonomous manner in order to perform task processing. The hardware accelerators and functional modules may be designed to each perform one or more small tasks in response to messages or control signals that may be generated by the various modules within the SOC as overall system execution progresses. For purposes of this disclosure, these small tasks are referred to as “micro-tasks.” In order for system to perform the required task processing, execution of the micro-tasks must occur in proper order, otherwise errors may be introduced or timing constraints may be violated. In this sense, execution of the tasks occur as a micro-task pipeline, even though the various micro-tasks may be executed on different hardware accelerators or functional modules.

In order to test and debug a new application specific integrated circuit (ASIC) or a new or modified application program running on an ASIC, various events that occur during execution of an application or a test program are traced and made available to external test equipment for analysis. A time stamp is formed to associate with each trace event of a sequence of trace events. Embodiments of the present invention provide a scheme taking advantage of the system trace infrastructure to provide to the user visibility into the operation of micro-task scheduling and key system events. These events are treated as generic events and encapsulated in system trace protocol (STP) messages and exported through the system trace module (STM) module. The nature of the events may require accurate time stamping that may be included, in addition to time stamping provided at the STM or at the trace receiver level.

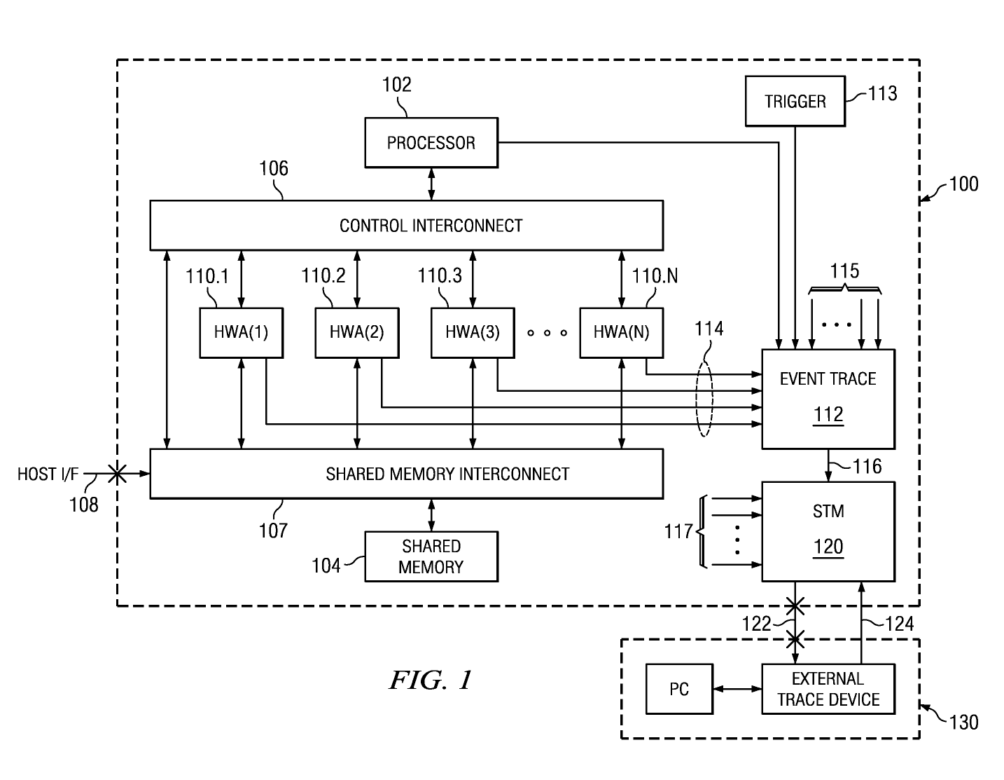

FIG. 1 is a block diagram illustrating an exemplary system on a chip (SOC) 100 with a system trace module (STM) 120 and a micro-task event trace buffer 112. For purposes of this disclosure, the somewhat generic term “ASIC” and the term “SOC” are used interchangeably to refer to any complex system on a chip that may include one or more processors 102, and one or more hardware accelerators 110.1-110.n, any of which may generate trace events that are useful for debugging the ASIC or an application running on the ASIC. These various processing units will be referred to herein as functional units. Tracing of software execution in general is well known and will not be described in further detail herein.

Exemplary SOC 100 includes multiple hardware accelerators 110 that are interconnected via control interconnect 106 to processor 102. The multiple hardware accelerators are also interconnected via shared memory interconnect 107 to shared memory 104. A host interface 108 is also provided to allow connection of an external processor to the shared memory via interconnect 107. Hardware accelerators 110 each contain control logic that allows each accelerator to operate in a somewhat autonomous manner, under control of processor 102.

For example, in order to perform video processing on a stream of video data, such as a JPEG encoded stream of video data, macroblocks must be decoded and processed. In order to perform the decoding and processing operation, each of the hardware accelerators are assigned a particular aspect of the process. In this embodiment of the invention, CPU 102 is the entry and exit point in “pipeline” composed of several nodes, where each node is one of the hardware accelerators 110. Each node includes a synchronization module configured to send and receive messages. Each node is able to activate is successor without CPU 102 intervention. The CPU and Nodes may exchange their data by the shared memory module 104, for example.

For example, the CPU may send an activation message to node 110.1. Node 110.1 processes a task on a block of data in the shared memory and then sends an activation message to node 110.2. Node 110.2 processes a task on the block of data in the shared memory and then sends an activation message to node 110.3. Node 110.3 processes a task on the block of data in the shared memory and then sends an activation message to the next node in the pipeline until the final node 110.n is reached. Node 110.n processes a task on the block of data in the shared memory and then sends a completion message to the CPU. For purposed of this disclosure, the processing performed by each node on a single macroblock of video data is referred to as a micro-task. In order to completely process each macroblock, an entire pipelined sequence of microtasks must be correctly performed by the set of nodes 110.1-110.n.

In a simple scheme, the CPU may wait until receipt of completion message, until it sends another activation message to node 110.1 to cause node 110.1 to begin processing another block of data in the shared memory. In this manner, the CPU is not burdened with keeping track of the progress of the processing being performed by the nodes. In order to further improve processing time, the CPU may periodically send several activation messages to node 110.1, rather than waiting for completion message from node 110.n. In one embodiment, each node acknowledges activation messages when the node is able to process it. Typically, the CPU would not send another activation message until the node as acknowledged the last one. Alternatively, in another embodiment, if a node cannot accept the activation message, it may respond to the activation message with an error response. In this manner, overlapped, pipelined operation of the various nodes may result.

In one embodiment, the messages may be sent via dedicated point to point links between the nodes and CPU. In another embodiment, the messages may be sent via a common bus 106 between the nodes and CPU using an addressing scheme, for example. In some embodiments, the messages may be transferred using the same bus as is used for accesses to the shared memory or registers, while in other embodiments there may be separate buses for message and data transfers.

With all of this semi-autonomous processing being performed by the various nodes, it may be difficult to detect and debug problems in execution of the overall task. In order to provide a mechanism to observe the operation of the pipeline, embodiments of the invention expose the operation of the micro-task pipeline. Exposing the micro-task pipeline allows tracking of several aspects, such as: individual micro-task execution time, latencies, bottlenecks, load balancing, dependencies, shared resource access efficiency, overall process optimization, etc.

As each node 110 receives messages from CPU 102 and from other nodes, control signals are activated. These signals may indicate various operations being performed within the node, such as: start load, stop load, start compute, stop compute, start store, stop store, start next node, etc. Each of these control signals are monitored and generate an event signal when they are activated. All of these event signals 114 are connected to event trace module 112 that records the occurrence of each event. Events are captured within a user defined capture window. A sampling window is defined to export periodically the captured events. The width of this sampling window is configured by software or through the debug GUI. Trigger logic 113 can be used to enable or disable event trace capture. The capture window may include one or more sampling windows. The captured events are then exported together with a time stamp at the end of the window.

In this exemplary embodiment, event trace module 112 may also be configured to record software events 115 that may originate from a program being executed on processor 102 or on a host processor coupled to interface 108. These software events are recorded by the program writing to a designated register address in event trace module 112. Event trace module interleaves the software events and the micro-task events in the order received. This allows further debugging correlation between the operation of the micro-task pipeline and the overall software being executed by the processor(s).

Micro-task tracing circuit 112 is coupled to STM 120 so that the sequence of micro-task events can be reported to an external trace device 130 and thereby correlated to instruction traces. This exposes the internal operation of the micro-task pipeline operation and allows debugging and optimization of the operation of the micro-task pipeline.

Other types of system information such as instruction and address traces and status signals 117 may also be connected to STM 120 and thereby reported to an external test system. As mentioned earlier, the STM included in this embodiment is capable of collecting data from up to 255 points. Of course, in other embodiments, a different type of STM may be used that has a greater or lesser capacity.

In this embodiment, when STM 120 is coupled to an external trace device 130 via interconnect 122, the STM may transmit sequences of trace events and time stamps directly to external trace receiver 130 as they are received. Interconnect 122 may include signal traces on a circuit board or other substrate that carries ASIC 100 which is connect to a parallel trace interface (PTI) 122 provided by ASIC 100. In this embodiment, PTI 122 is compatible with the MIPI standard (Mobile Industry Processor Interface). Interconnect 122 may include a connector to which a cable or other means of connecting to external trace receiver 130 is coupled. An optional return channel 124 such as serial bus/P1149.7 may be used to provide control information from external trace device 130 to ASIC 100.

External trace device 130 may be any of several known test systems for performing debugging and tracing using the MIPI protocols. Such systems generally include a computer (PC) that allows a user to observe the event traces on a graphical user interface and to control the debugging process by specifying user defined capture and sampling windows that are then communicated to the system under test 100 via the reverse channel 124.

In a second mode of operation, an external trace device may not be connected to ASIC 100 during a trace capture episode, or there may not be a provision for connecting an external trace device. In this mode, STM 120 transmits the sequences of trace data and associated time stamps to an embedded trace buffer (ETB) within ASIC 100 via an internal bus or other interconnect. In this case, after a debug session, the contents of the ETB may be transferred to another device by using another interface included within ASIC 100, such as via a USB (universal serial bus) or a JTAG port, for example. Alternatively, after a debug session an external trace receiver 130 may then be connected to ASIC 100 and the contents of the ETB may be accessed by STM 120 and then transmitted to external trace device 130 via interconnect 120.

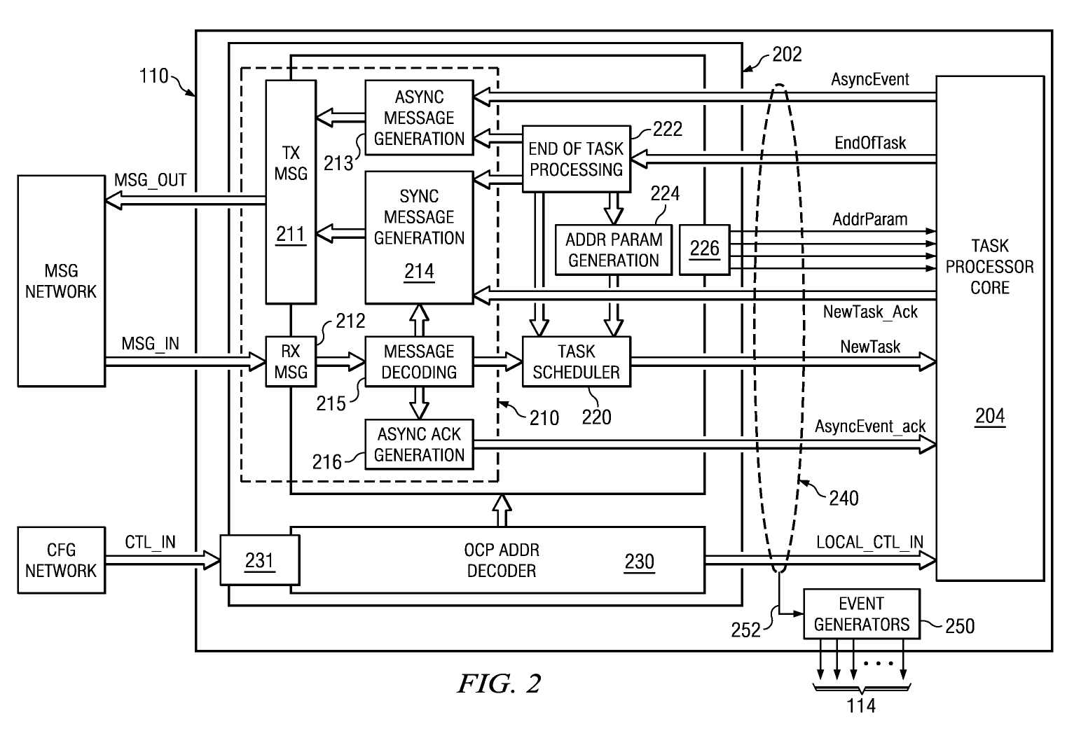

FIG. 2 is a block diagram illustrating an exemplary node 110 with a synchronization module for use in the system of FIG. 1. In this embodiment of the invention, the various nodes 110.1-110.n include a distributed synchronization module 202, referred to herein as a “syncbox” that is used to coordinate the activities of the various modules. Syncbox 202 is coupled to processor core 204, which is configured to perform one or more tasks on blocks or streams of data. Typically, task processing core 204 is designed and optimized for a particular type of processing, such as for macro block processing in a video system, however in some embodiments it may be a general purpose processor, or a specific purpose processor such as a digital signal processor, for example. Together, embodiments of syncbox 202 and processor core 204 form the hardware accelerator nodes of FIG. 1, for example.

Syncbox 202 includes a network interface 210 that is configured to send and receive messages to and from other synchronization modules, a task scheduler 220 that is configured to select a task in response to a received message, a configuration interface 230 that is configured to receive task information from a host processor, a task processor interface 240 that is configured to initiate the selected task on a task processor coupled to the synchronization module, and event generators 250 that are configured to generate event signals 114 that are then sent to the event trace module 112 of FIG. 1.

Network interface 210 includes asynchronous message generation logic 213, synchronous message generation logic 214, transmission message port 211, received message decoder logic 215, asynchronous acknowledgement logic 216 and received message port 212. Port connectors 211 and 212 are designed to provide a physical connection to a message network, such as control interconnect 106 of FIG. 1. Various embodiments of syncbox 202 may implement various types of connections, depending on the message network structure of the system that will be using syncboxes. For example, messages may be conveyed on a serial bus or a parallel bus. The message network may have a shared parallel topology, a ring topology, a star topology, or other types of known network topologies.

The message receive port is used to receive activation and acknowledgement messages from other nodes. MSG_IN port 212 is a slave interface, 16-bits wide, write-only. Input messages are stored in an RxMessage register within message receive port 212 that holds each received message. In this embodiment, the RxMsg register is 16 bits. 16 bits are used to convey a Boolean value and another four bits received on another bus are used for message addressing. In this embodiment, the RxMsg register is accessible from both the message input port 212 and the control input port 231. Message decoding logic 215 decodes each message and updates task scheduler logic 220 accordingly. Asynchronous acknowledgements are generated after decoding an acknowledgement message and conveyed to the task processor via ack logic 216.

The message output port is used to send activation and acknowledgement messages to other nodes. In this embodiment, the message output port is a master interface, 16-bit wide, write-only. The MSG_OUT interface is shared between all tasks. Prior to being sent, the messages are stored in a TxMessage register within output port 211. Asynchronous messages are generated in message generation logic 213 and have the general form defined in Table 1. Synchronous messages are generated in message generation logic 214 and have the general form defined in Table 2.

TABLE 1
bit-field asynchronous message description

| Bits position | description |
|---|---|
| b0-b3 | Source node index. Gives the identifier of the node who has |
| | sent the activation message |
| b4-b7 | For activation message: |
| | Source event index: Give the event identifier to which the |
| | acknowledge message must refer to. |
| | For acknowledge message: |
| | Source task Id: this field contains the id of the task in |
| | charge of processing the async event. But meaningless since |
| | not checked at destination node. |
| b8-b11 | For activation message: |
| | Destination task index. Gives the identifier of the task to |
| | be activated on the destination node |
| | For acknowledge message: |
| | Destination event id; id of the async event line to be |
| | acknowledged |
| b12 | Synchronous/asynchronous signal. set to 1 for |
| | asynchronous message |
| b13 | Activation or Acknowledge, set to 1 for activation, 0 for |
| | acknowledge |
| b14 | AckReq: bit set to 1 if a acknowledge message must be sent |
| | back upon reception of a asynchronous activation message. |
| | Meaningless for acknowledge message |
| b15 | reserved |

TABLE 2
bit-field synchronous message description

| Bits position | description |
|---|---|
| b0-b3 | source node index. Gives the identifier of the node who has |
| | sent the activation message |
| b4-b7 | source task index: Give the task identifier to which the |
| | acknowledge must be sent to. |
| b8-b11 | destination task index. Gives the identifier of the task to be |
| | activated on the destination node |
| b12 | Synchronous/asynchronous signal. set to 0 for synchronous |
| | message |
| b13 | Activation or Acknowledge, set to 1 for activation, 0 for |
| | acknowledge |
| b14 | AckReq: bit set to 1 if a acknowledge message must be sent |
| | back upon reception of a synchronous activation message. |
| | Set to 0 for fake message to avoid sending acknowledge to |
| | Bit is meaningless for acknowledge message. |
| b15 | reserved |

The control input port is used to receive configuration information from the system host processor. In this embodiment, the control input port is a 32-bit interface. A 32-bit address and 32-bit data value is transferred for each control word. In response to receiving a command word, the on-chip protocol (OCP) address decoder logic 230 decodes the command word and provides an acknowledgement to the host processor to indicate when the command has been processed and to indicate if the command is valid for this node. In this embodiment, Syncbox memory size is limited to 2 Kbyte, therefore only eleven address bits are needed.

Task scheduler 220 receives activation messages from input message decoding logic 215, end of task messages from end of task processing logic 222, and parameter addressing info from parameter address generation logic 224. Once all criteria for a task have been met, the new task signal of task processor interface 240 is asserted to instruct task processor 204 to start the next task. The Syncbox enables the node core to read the configuration parameter's ParamAddress 226 when the start command is issued.

In order to avoid activating a task while it is still running, a simple two state-finite state machine (FSM) may be implemented. At initialization, the FSM is in the Core_ready state. When the Syncbox sends the start command, the FSM goes into the Core_busy state. As soon as the EndOfTask signal is detected and the EndOfTask FIFO is not full, the FSM goes back to the Core_ready state. For a multi-task node, multiple FSMs are implemented as above, since the FSM applies for each task. Each FSM is handled independently from the others.

The NewTask_Ack signal of interface 240 is used by the node core to acknowledge to the Syncbox that the “NewTask Command” has been detected and that the task is started. Upon reception of the NewTask_Ack signal, the acknowledgement message is sent back to the activator in case the activation counter was at its maximum value.

The EndOfTask signal of interface 240 is latched in a 2 stage-FIFO EoT_FIFO in end of task logic 222. The FIFO pointer is initialized to 0 and incremented on EndOfTask signal detection. It is decremented when all the activation messages have been sent and all the corresponding acknowledgement messages have been received. The FIFO allows de-correlation of the end of the task on the node core and the end of the “post processing” in the Syncbox. For example, it may happen that the message can not be transmitted, due to message network congestion, or acknowledgement message not received but the node core availability must be exploited as soon as possible. The Syncbox allows a maximum of two tasks completion, processing two consecutive MB, (or MB pair) while a message associated to task T1 is still not sent. In that case, the EoTFIFO_full flag is set to true. The Syncbox internal FSM reflecting the node core status must be switched to the ready state as soon as the end of task is detected and if the EndOfTask FIFO is not full.

The AsyncEvent input of interface 240 allows asynchronous message transfers between two nodes. It is composed of N input signals, N being a generic parameter, specific to each implementation. With this i/f, the node core can signal another node a specific event has occurred during the task processing time, but the node is able to continue its execution. The node core eventually sets a bit in an internal register [ex status register, error register] to allow the destination node to detect what was the cause of the message, if needed. Upon detection of the active pulse, async message logic 213 sends an asynchronous activation message. A specific register is dedicated to this interface signal; it is programmed at frame set-up and contains the destination node HWA and task identifier.

An acknowledge signal may be expected to be received. Thus, the node can issue several asynchronous messages prior to them being processed by the destination node because the transmission is not gated by acknowledge message reception. Once the asynchronous task has been processed, the destination node will send an asynchronous acknowledge signal message to allow the node core take an action. Async ack logic 216 asserts the AsyncEvent_Ack signal of interface 240. The Acknowledge message requirement is programmable at setup time. Each asynchronous line has a status register AsyncAck set to 1 to indicate an acknowledge message is required, 0 otherwise. If no acknowledge message is expected, the corresponding async_event_ack line is set to 1 immediately after the asynchronous message has been sent. This to avoid a situation in which two consecutive events are notified to the Syncbox by the node core, while the Syncbox doesn't respond in time.

Various signals in interface 240 or elsewhere within syncbox 202 or task processor core 204 may be tapped and connected 252 to event generator logic 250. Event generator logic 250 detects each time a signal 252 is asserted and forms a one cycle pulse on a corresponding output event line 114. Conversely, event generator 250 may be configured to detect when a signal 252 is de-asserted and generate a one cycle pulse on a corresponding output event line 114. Signals are selected for connection to event generator 250 in order to expose the operation of the micro-task pipeline that is formed by the cooperative effort of the group of modules 110.1-110.n. In this embodiment, signals that indicate the following are selected: start load, stop load, start compute, stop compute, start store, stop store, start next node, etc.

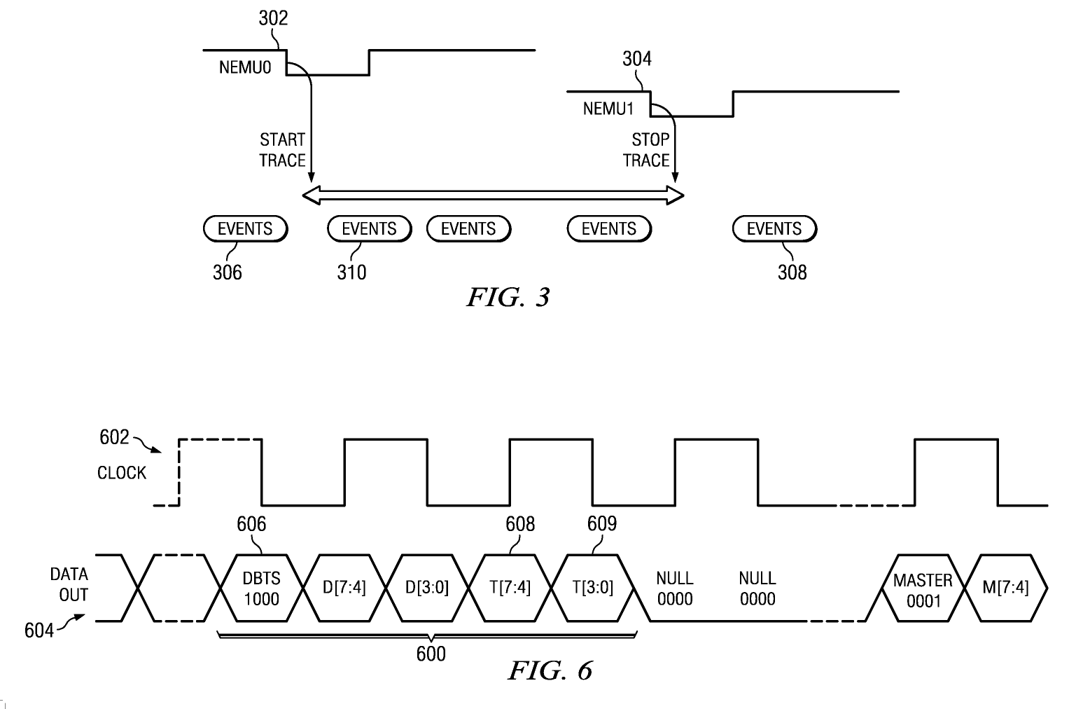

FIG. 3 is a time line illustrating triggering of event tracing. Trigger logic 113 of FIG. 1 is coupled to various signals and busses that may be used to trigger the start and end of event tracing. Trigger logic 113 is configured by instructions sent from external trace device 130 during a debug session. The general operation of trigger detection is well known and does not need to be further described herein. When a trigger condition 302 is sensed, then events 310 occurring afterwards are traced by event trace logic 112. Events 306 that occurred prior to the trigger are not traced. When a second trigger condition 304 is sensed, tracing stops and events 308 that occur later are not traced.

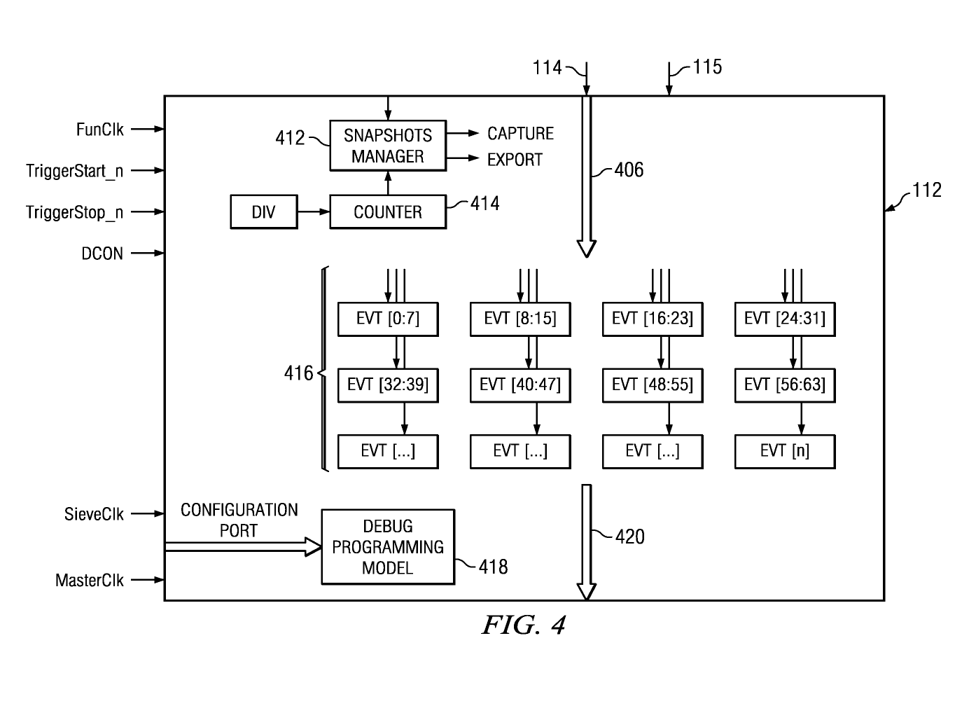

FIG. 4 is a more detailed block diagram of event trace module 112 of FIG. 1. In this embodiments, a snapshot manager 412 is accessible via configuration port 418 coupled to the STM and thereby to an external monitoring system to specify which set of events to collect at a particular time. A configurable counter 414 is set to specify a window size for capturing the selected type of events. A trigger may also be specified to initiate or terminate event collection, as described above. The selected events are transferred via bus 406 to a register file 416. When the window time expires, the collected events are sent to the STM via bus 420 where a header and time stamp are added and then exported to the external monitoring system. Other embodiments of the invention may not include counter 414, may have more than one trigger signal input, or have other arrangements to start and stop tracing, for example.

Any micro-task event may be exposed to a user on the external monitoring system, such as external test and debug system 130 of FIG. 1. As used herein, the term “user” generally refers to a software or hardware developer or team that is testing the SOC or evaluating operation of the SOC while selected application programs are executed on the SOC. However, it should be understood that a user may also be a computerized system that is programmed to analyze the instruction stream traces and event messages and propose or perform optimizations to the application software or to the SOC hardware configurations.

In this embodiment, each event received during the capture window is stored in one of the registers 416. As was mentioned earlier, in this embodiment up to 255 events may be captured during each window. Events are encoded in an eight bit field, as indicated in Table 3. In other embodiments, the tracing capacity may be larger or smaller. If an event occurs two times during a sampling window then a message is exported immediately without waiting for the expiration of the sampling window and a new sampling window period starts for capturing new events. This will result in two separate messages reporting the first and second pulse of the event. In other words the same event (ex: start load for HWA 1) cannot be reported two times in the same sampling window because of the encoding scheme used in this embodiment, but all the events are captured. An overflow can occur only when a message cannot be exported and the event capture buffer is full. Another embodiment may include a coding scheme to allow reporting of more than one occurrence of an event during a sampling window.

TABLE 3
System event encoding field

| 8-bit field | |
|---|---|
| Event encoding | Description |
| 0x00 | No event |
| 0x01 | Event 1 |
| 0x02 | Event 2 |
| 0x03 | Event 3 |
| . . . | . . . |
| 0xFE | Event 254 |
| 0xFF | Event 255 |

When the sampling window expires, the instrumentation module captures a snapshot of all the events from the selected events group. It captures the overflow indication if it occurred within the sampling window.

### Time Stamping

Time stamping is performed by the trace receiver and corrected by the STM queue offset encapsulated in DTS message. The STP protocol requires that every high level hardware message be marked by a time stamp to signal each high level message boundary. Therefore the last STP message in the sequence is a DTS (data time stamp) message. The time stamp requires only an extra byte injected by the STM. The time stamp (TS) value is set according to the number of pending messages present in the STM queue.

Event trace module 112 also forms a local time stamp in order to improve the accuracy of the event trace. The last write to the STM TS address includes local time stamping. This applies only to HW messages. The granularity of this local time stamp depends on events and/or sampling windows separation. By default the finest granularity is selected. If an event occurs within the next 2⁸ x slots snapshot manager 412 does not scale up granularity, and local time stamp will report the number of event trace cycles between two events or two sampling windows depending on a message generation configuration, defined in event trace configuration register bit located in configuration registers 418. If no event occurs within the next 2⁸ x slots, snapshot manager 412 will scale up granularity by a 2¹ x factor. If an event occurs within the next 2⁹ x slots, snapshot manager 412 will extend the local time stamp capture with the current time stamp granularity, switch back to default granularity, and reset the local time base. If no event occurs within the next 2⁹ x slots, snapshot manager 412 will scale up granularity by a 2¹ x factor. If an event occurs within the next 2¹⁰ x slots, snapshot manager 412 will extend the local time stamp capture with the current time stamp granularity, switch back to default granularity, and reset the local time base. If no event occurs within the next 2¹⁰ x slots, snapshot manager 412 will scale up granularity by a 2¹ x factor. The 8-bit time stamp window can get 16 x positions as defined in Table 4. Note that when the granularity scaling factor reaches 64, if further scaling is required it shall be made by a 4× factor instead to 2× in order to keep the local time stamp message as compact as possible.

TABLE 4
Local time stamp granularity signaling

| | | 8-bit local TS | Granularity |
|---|---|---|---|
| G[3:0] | Local Time Stamp granularity | Window Shift | Scaling Factor |
| 0x0 | Default = finest granularity | 0 | 1 |
| | Instrumentation Port clock | | |
| | frequency/n | | |
| 0x1 | | 1 | 2 |
| 0x2 | | 2 | 4 |
| 0x3 | | 3 | 8 |
| 0x4 | | 4 | 16 |
| 0x5 | | 5 | 32 |
| 0x6 | | 6 | 64 |
| 0x7 | | 8 | 256 |
| 0x8 | | 10 | 1024 |
| 0x9 | | 12 | 4096 |
| 0xA | | 14 | 16384 |
| 0xB | | 16 | 65536 |
| 0xC | | 18 | 262144 |
| 0xD | | 20 | 1048576 |
| 0xE | | 22 | 4194304 |
| 0xF | | 24 | 16777216 |

Note:
It is expected that the local time stamping value saturates if no event has been detected within the 2³² x slots (G[3:0] = 0xF and LTS[7:0] = 0xFF).

### Message Interleaving

The Event Trace messages can be interleaved with OCP (on chip protocol) watch-point messages and application software messages. When STM detects a write from a master different than previous access a MASTER message is injected in the queue.

The software message and system event trace (SMSET) component 112 signals through a register MReq Info located in manager module 412 if the write access has been triggered from system event 114 detection or from software instrumentation 115. The Events Trace and software messages are seen by the STM component as two different masters (hardware/software).

The SMSET master port and the associated Instrumentation NoC (network on the Chip) master agent supports OCP write burst, in order to reduce trace export surplus on the PTI interface, due to instrumentation flows interleaving at instrumentation NoC level.

### Overflow

In case SMSET hardware 112 detects an overflow it signals the presence of overflow to the STM module by writing to a specific address. Table 5 highlights the STM addresses dedicated to overflow signaling.

TABLE 5
STM addresses dedicated to overflow signaling

| 32-bit | |
|---|---|
| STM Byte | |
| address | Contents |
| 0x000 | Non-time-stamped data, no overflow |
| 0x004 | Time-stamped data, no overflow |
| 0x008 | Non-time-stamped data, 1 overflow |
| 0x00C | Time-stamped data, 1 overflow |
| 0x010 | Non-time-stamped data, 2 overflows |
| 0x014 | Time-stamped data, 2 overflows |
| . . . | . . . |
| 0x3F8 | Non-time-stamped data, 127 or more overflows |
| 0x3FC | Time-stamped data, 127 or more overflows |

### Configuration Registers

Configuration logic 418 contains a set of registers that control the operation of SMSET module 112. These registers may be accessed by a user on an external test system 130 via the configuration port. The various registers are listed in Table 6.

TABLE 6
System Event Trace Configuration Registers

| Offset | Debug register name | Ownership |
|---|---|---|
| 0x000 | identification register | No ownership |
| 0x010 | system configuration register | |
| 0x014 | status register | |
| 0x024 | configuration register | Has to be claimed |
| 0x028 | System event sampling window register | Same owner as |
| 0x030 | System event detection enable register 1 | configuration register |
| 0x034 | System event detection enable register 2 | |
| | (if number of events > 32) | |
| 0x038 | System event detection enable register 3 | |
| | (if number of events > 64) | |
| 0x03C | System event detection enable register 4 | |
| | (if number of events > 96) | |
| 0x040 | System event detection enable register 5 | |
| | (if number of events > 128) | |
| 0x044 | System event detection enable register 6 | |
| | (if number of events > 160) | |
| 0x048 | System event detection enable register 7 | |
| | (if number of events > 192) | |
| 0x04C | System event detection enable register 8 | |
| | (if number of events > 224) | |

### Component Ownership

Some of the resources can be owned either by the application or by the debugger, as indicated in Table 6. The ownership is required to configure or program the system event trace module. In other words, ownership determines if write access is granted to the configuration registers. The instrumentation resource ownership is exclusive. Hence, simultaneous use of resources by both debugger and application is not permitted. However, the debugger can forcibly seize ownership of trace resources. Note that a read access does not require ownership; therefore, either party can read any configuration registers with or without ownership.

The eight 32-bit system event detection enable registers allow a user on a remote test system to enable various event signals for tracing. All events may be enabled by setting all bits to a logic one, or selected events may be enabled by only setting to logical one selected bits in the enable registers that correspond to the events of interest. In this manner, the size of the trace message can be optimized.

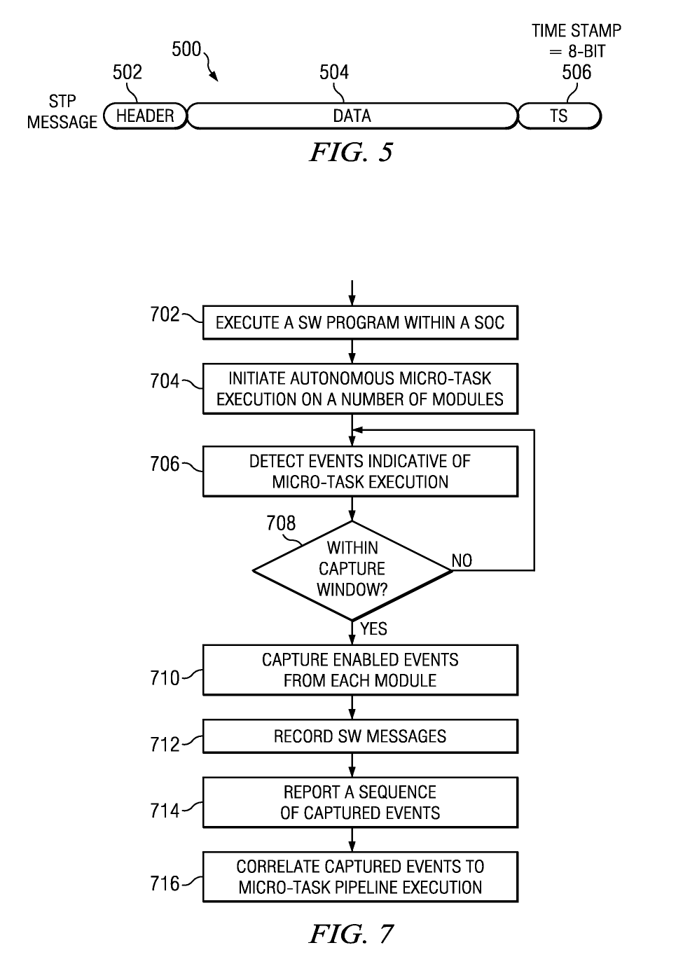

FIG. 5 illustrates the general format of an STP message 500 with a time stamp. Dxx STP messages do not have a time stamp, while DxxTS STP messages includ a time stamp. STP message 500 includes a header 502, a variable length data portion 504, and an eight bit time stamp 506. Table 7 illustrates the high-level STP messages. A D8 eight bit event ID message, a D32 n×32 bit data message, and a D8TS eight bit status message with time stamp messages are illustrated. Other data sizes may also be accommodated.

TABLE 7
High level STP message

| | Byte 0 | | Byte 1 | | Byte 2 | | Byte 3 | |
|---|---|---|---|---|---|---|---|---|
| STP | 0 | 7 | 8 | 15 | 16 | 23 | 24 | 31 |

| D8 | EVT-ID | | |
|---|---|---|---|
| D32 | PM_evt1 | PM_evt2 | PM_evt3 |

| | | | |
|---|---|---|---|
| D8TS | TS ACC | E | Time Stamp |

FIG. 6 is a timing diagram illustrating a data stream 604 conforming to STP format which includes a time stamp 608-609. The STP format transmits four bits on four-bit interconnect 122, referring to FIG. 1, during each phase of clock signal 602. In this instance, a D8TS (eight-bit data and a time stamp) message identifier 606 indicates an eight bit trace data value and a time stamp follows. The STM port is a 4-bit wide double data rate (DDR) interface operating around 100 MHz. The throughput is therefore 100 Mbytes/sec. The power management events are typically low activity events and should not consume a large amount of bandwidth. Depending on debug scenarios the user will be able to interleave other hardware or software instrumentation flows and correlate them. For example, a sequence of micro-task event reports may be interleaved with a sequence of instruction execution traces.

The instrumentation flow interleaving across interconnect 122, referring again to FIG. 1, is managed at Debug Subsystem level by STM 120. The initiator write burst sequence insures that the switch will always occur on a burst boundary. Therefore the STP message write sequence will be preserved and never disrupted by other instrumentation flows.

Software and hardware initiators can be interleaved. By adding instrumentation code to the software being executed on system 100, the user will be able evaluate latencies and understand any dependencies preventing the correct operation of the micro-task pipeline.

### System Events Trace Messages

Tables 8-12 illustrate various trace messages emitted by system event trace module 112 via STM 120 to external test system 130. Table 8 illustrates a message in which only one event occurred during the sampling window. Table 9 illustrates a message in which two events were detected during a sampling window. Tables 10-12 illustrate a message in which five, 125, and 254 events were detected, respectively, during a sampling window.

TABLE 8
System event message - 1 event detected

| STP | | | | | |
|---|---|---|---|---|---|
| Header | Byte 0 | Byte 1 | Byte 2 | Byte 3 | Byte 4 |
| D32TS | Event ID | 0x0 | Local time | Local time | STM Time |
| | [0] | | stamp | stamp | stamp |
| | | | granularity | | |

TABLE 9
System event message - 2 events detected

| STP | | | | | |
|---|---|---|---|---|---|
| Header | Byte 0 | Byte 1 | Byte 2 | Byte 3 | Byte 4 |
| D32TS | Event ID | Event ID | Local time | Local time | STM Time |
| | [0] | [1] | stamp | stamp | stamp |
| | | | granularity | | |

TABLE 10
System event message - 5 events detected

| STP | | | | | |
|---|---|---|---|---|---|
| Header | Byte 0 | Byte 1 | Byte 2 | Byte 3 | Byte 4 |
| D32 | Event ID | Event ID | Event ID | Event ID | |
| | [0] | [1] | [2] | [3] | |
| D32TS | Event ID | 0x0 | Local time | Local time | STM Time |
| | [4] | | stamp | stamp | stamp |
| | | | granularity | | |

TABLE 11
System event message - 125 events detected

| STP | | | | | |
|---|---|---|---|---|---|
| Header | Byte 0 | Byte 1 | Byte 2 | Byte 3 | Byte 4 |
| D32 | Event ID | Event ID | Event ID | Event ID | |
| | [0] | [1] | [2] | [3] | |
| D32 | Event ID | Event ID | Event ID | Event ID | |
| | [4] | [5] | [6] | [7] | |
| D32 | Event ID | Event ID | Event ID | Event ID | |
| | [120] | [121] | [122] | [123] | |
| D32TS | Event ID | 0x0 | Local time | Local time | STM Time |
| | [124] | | stamp | stamp | stamp |
| | | | granularity | | |

TABLE 12
System event message - 254 events detected

| STP | | | | | |
|---|---|---|---|---|---|
| Header | Byte 0 | Byte 1 | Byte 2 | Byte 3 | Byte 4 |
| D32 | Event ID | Event ID | Event ID | Event ID | |
| | [0] | [1] | [2] | [3] | |
| D32 | Event ID | Event ID | Event ID | Event ID | |
| | [4] | [5] | [6] | [7] | |
| D32 | Event ID | Event ID | Event ID | Event ID | |
| | [248] | [249] | [250] | [251] | |
| D32TS | Event ID | Event ID | Local time | Local time | STM Time |
| | [252] | [253] | stamp | stamp | stamp |
| | | | granularity | | |

Table 13 illustrates a message that reports an overflow along with three detected events.

TABLE 13
System event message with overflow(s) - 3 events detected

| STP | | | | | |
|---|---|---|---|---|---|
| Header | Byte 0 | Byte 1 | Byte 2 | Byte 3 | Byte 4 |
| OVRF | Event ID | Event ID | Event ID | 0x0 | |
| | [0] | [1] | [2] | | |
| D32TS | 0x0 | 0x0 | Local time | Local time | STM Time |
| | | | stamp | stamp | stamp |
| | | | granularity | | |

FIG. 7 is a flow chart illustrating operation of the system event tracing logic of FIG. 1 on a system on a chip. The process is started by executing 702 one or more software programs on the system on a chip (SOC). This may be a particular application that is being used to optimize hardware configuration settings of the SOC, or an application that is being optimized or debugged. A window size is selected for reporting event traces. As monitoring progress, the window size may be changed as needed to trade-off accuracy versus STM throughput.

The software program initiates autonomous micro-task execution by a number of coupled functional modules within the SOC. As described in more detail above, the various functional modules form a pipeline by executing micro-tasks on blocks of shared data.

A plurality of events is detected 706 within each of the functional units indicative of progression of micro-task execution within each functional unit. These events are control signals that may indicate various operations being performed within the node, such as: start load, stop load, start compute, stop compute, start store, stop store, start next node, etc. Each of these control signals are monitored and generate an event signal when they are activated.

A capture window 708 is triggered via one or more triggering conditions, such as a data pattern match, and address match, an iteration count down, etc. The capture window may be closed by another trigger event, or be expiration of a time counter, for example. A capture window 708 includes one or more sampling windows. A sampling window is defined to periodically export messages. A capture window defines when hardware events can be captured. Triggers can be used to define a capture window boundary. The capture 710 of events occurs only during the capture window and events from all of the functional modules are captured. Alternatively, only selected events may be captured during the capture window by programming the event enable configuration registers to enable only a portion of the events.

One or more software messages initiated by the software program may also be recorded 712, wherein the recorded software messages are interleaved with the captured plurality of events. These software events are recorded by the program writing to a designated register address in event trace module 112

The captured plurality of events is reported 714 to an external test system via the PTI interface connected to the SOC, as described in more detail above. The sequence of captured events is correlated 716 to the execution of the software program. During execution of the application program, traces are made of the program execution using known techniques. These traces are then reported 714 as a sequence of execution traces responsive to executing the one or more software programs.

Correlation is performed by using the time stamps to align the event traces with traces of program execution that are also gathered via the STM using known software tracing techniques. The correlated event and software traces may be displayed on a graphical user interface of the test system using a known display system, such as “Code Composer Studio” available from Texas Instruments, Inc.

In this manner, the operation of complex embedded micro-task pipelines may be exposed to allow fine grain visibility into complex multi-node application specific processors. It allows tracking corner cases which cannot be indentified in a simulated environment, optimizing the overall micro-process's sequence of execution cycles, minimizing power consumption, correlating software tasks execution and system level events, etc.

### System Application

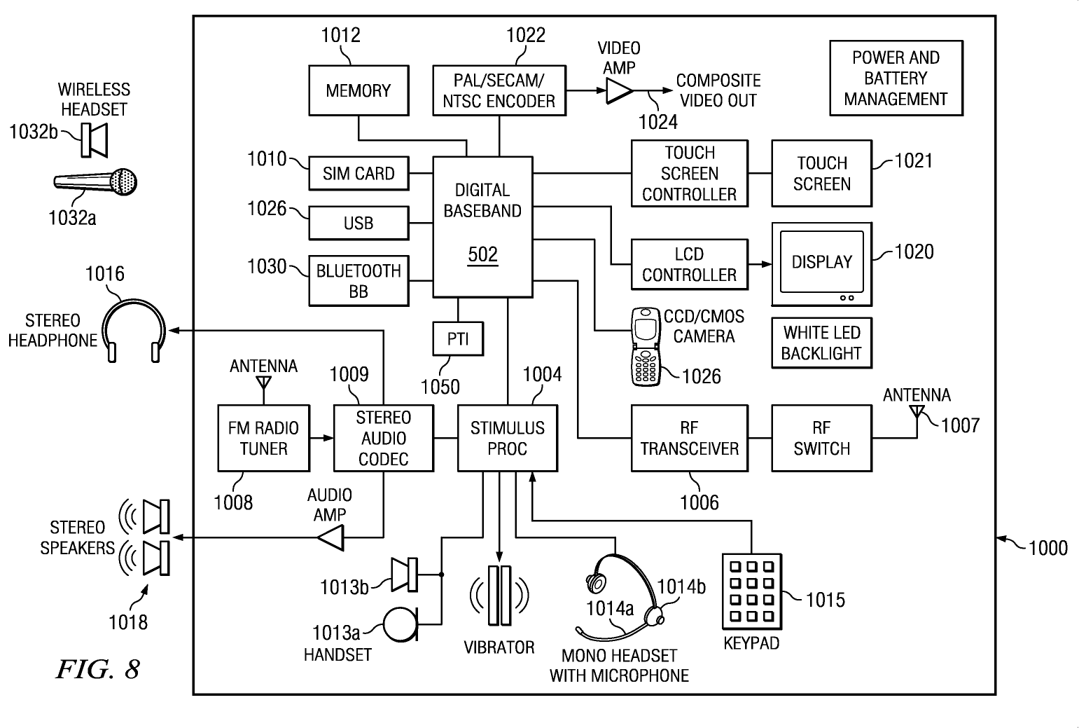

FIG. 8 is a block diagram of mobile cellular phone 1000 for use in a cellular network. Digital baseband (DBB) unit 1002 can include a digital processing system (DSP) that includes embedded memory and security features. Stimulus Processing (SP) unit 1004 receives a voice data stream from handset microphone 1013a and sends a voice data stream to handset mono speaker 1013b. SP unit 1004 also receives a voice data stream from microphone 1014a and sends a voice data stream to mono headset 1014b. Usually, SP and DBB are separate ICs. In most embodiments, SP does not embed a programmable processor core, but performs processing based on configuration of audio paths, filters, gains, etc being setup by software running on the DBB. In an alternate embodiment, SP processing is performed on the same processor that performs DBB processing. In another embodiment, a separate DSP or other type of processor performs SP processing.

RF transceiver 1006 includes a receiver for receiving a stream of coded data frames and commands from a cellular base station via antenna 1007 and a transmitter for transmitting a stream of coded data frames to the cellular base station via antenna 1007. In this embodiment, a single transceiver can support multi-standard operation (such as EUTRA and other standards) but other embodiments may use multiple transceivers for different transmission standards. Other embodiments may have transceivers for a later developed transmission standard with appropriate configuration. RF transceiver 1006 is connected to DBB 1002 which provides processing of the frames of encoded data being received and transmitted by the mobile UE unit 1000.

The basic DSP radio can include discrete Fourier transform (DFT), resource (i.e. tone) mapping, and IFFT (fast implementation of IDFT) to form a data stream for transmission. To receive the data stream from the received signal, the radio can include DFT, resource de-mapping and IFFT. The operations of DFT, IFFT and resource mapping/de-mapping may be performed by instructions stored in memory 1012 and executed by DBB 1002 in response to signals received by transceiver 1006.

DBB 1002 contains multiple hardware accelerators for decoding a video stream for presentation on display 1020 and a software message and system event trace module (SMSET) that performs micro-task activity monitoring on the hardware accelerators as described above with respect to FIGS. 1-7. The SMSET is coupled to the DSP and to the various hardware accelerators internal to DBB 1002 and is operable to collect trace events to aid in debugging the video processing and the various DSP radio tasks described above. A sequence of trace events and time stamps can be transmitted to an external trace receiver when one is coupled to PTI connector 1050. When an external trace receiver is not coupled to PTI connector 1050, then the stream of trace events and time stamps formed may be stored in an embedded trace buffer. From there, the stream of trace events and time stamps may be transferred to an external analysis device via USB port 1026 or Bluetooth port 1030, for example.

DBB unit 1002 may send or receive data to various devices connected to universal serial bus (USB) port 1026. DBB 1002 can be connected to subscriber identity module (SIM) card 1010 and stores and retrieves information used for making calls via the cellular system. DBB 1002 can also connected to memory 1012 that augments the onboard memory and is used for various processing needs. DBB 1002 can be connected to Bluetooth baseband unit 1030 for wireless connection to a microphone 1032a and headset 1032b for sending and receiving voice data. DBB 1002 can also be connected to display 1020 and can send information to it for interaction with a user of the mobile UE 1000 during a call process. Display 1020 may also display pictures received from the network, from a local camera 1026, or from other sources such as USB 1026. DBB 1002 may also send a video stream to display 1020 that is received from various sources such as the cellular network via RF transceiver 1006 or camera 1026. DBB 1002 may also send a video stream to an external video display unit via encoder 1022 over composite output terminal 1024. Encoder unit 1022 can provide encoding according to PAL/SECAM/NTSC video standards.

### Other Embodiments

As used herein, the terms “applied,” “coupled,” “connected,” and “connection” mean electrically connected, including where additional elements may be in the electrical connection path. “Associated” means a controlling relationship, such as a memory resource that is controlled by an associated port. The terms assert, assertion, de-assert, de-assertion, negate and negation are used to avoid confusion when dealing with a mixture of active high and active low signals. Assert and assertion are used to indicate that a signal is rendered active, or logically true. De-assert, de-assertion, negate, and negation are used to indicate that a signal is rendered inactive, or logically false.

Although the invention finds particular application to Digital Signal Processors (DSPs), implemented, for example, in an Application Specific Integrated Circuit (ASIC), it also finds application to other forms of processors. An ASIC may contain one or more megacells which each include custom designed functional circuits combined with pre-designed functional circuits provided by a design library.

While the invention has been described with reference to illustrative embodiments, this description is not intended to be construed in a limiting sense. Various other embodiments of the invention will be apparent to persons skilled in the art upon reference to this description. For example, another embodiment may use another test and debug interface that is not related to MIPI. In various embodiments, narrow or wide versions of P1149.7 may be used. Other embodiments may use interconnects that are not P1149.7 based.

In some embodiments, the ASIC may be mounted on a printed circuit board. In other embodiments, the ASIC may be mounted directly to a substrate that carries other integrated circuits. Various sizes and styles of connectors may be used for connection to an external trace receiver.

The embodiment described herein included clock sources generated using one or more phase locked loops that may be configured to produce different frequencies. In another embodiment, a fixed oscillator or time base may be used. Various combinations of frequency dividers or pulse gating may be used to vary the effective clock frequency to various clock domains.

While a cellular handset embodying the invention was described herein, this system description is not intended to be construed in a limiting sense. Various other system embodiments of the invention will be apparent to persons skilled in the art upon reference to this description. For example, an ASIC embodying the invention may be used in many sorts of mobile devices such as a personal digital assistants (PDA), audio/video reproduction devices, global positioning systems, radios, televisions, personal computers, etc, or any device where minimization of power dissipation is important. Other embodiments may be used in fixed or typically non-mobile devices, such as computers, televisions or any device where minimization of power dissipation is important.

An embodiment of the invention may include a system with a processor coupled to a computer readable medium in which a software program is stored that contains instructions that when executed by the processor perform the functions of modules and circuits described herein. The computer readable medium may be memory storage such as dynamic random access memory (DRAM), static RAM (SRAM), read only memory (ROM), Programmable ROM (PROM), erasable PROM (EPROM) or other similar types of memory. The computer readable media may also be in the form of magnetic, optical, semiconductor or other types of discs or other portable memory devices that can be used to distribute the software for downloading to a system for execution by a processor. The computer readable media may also be in the form of magnetic, optical, semiconductor or other types of disc unit coupled to a system that can store the software for downloading or for direct execution by a processor.

It is therefore contemplated that the appended claims will cover any such modifications of the embodiments as fall within the true scope and spirit of the invention.

What is claimed is:

1. A digital system, comprising:
a plurality of interconnected functional modules each having one or more event signal outputs, wherein each module is configured to execute one or more tasks and to assert an event signal on its respective one or more event signal outputs to indicate progress of execution of a task;
an event monitor connected to receive from each of the plurality of functional modules the one or more event signal lines, wherein the event monitor is configured to record the occurrence of each event signal assertion; and
an interface module coupled to the event monitor having an output for transferring an indication of each event signal assertion to an external monitoring system.

2. The digital system of claim 1, wherein each of the plurality of functional modules comprises circuitry configured to produce a plurality of control signals, wherein each functional module has a set of event signal outputs corresponding to a portion of the control signals of that functional module.

3. The digital system of claim 2, wherein at least one of the functional modules further comprises event generation circuitry coupled to receive the portion of control signals of that module, wherein the event generation circuitry is configured to assert an event signal cycle on an event signal output each time a corresponding one of the control signals is asserted.

4. The digital system of claim 1, wherein the event monitor is configured to record the occurrence of each event signal assertion only during a designated capture window.

5. The digital system of claim 1, wherein the event monitor is configured to attach a time stamp to each reported set of event recordings.

6. A digital system comprising a functional module having a plurality of event signal outputs, wherein the module is configured to execute one or more tasks and to assert an event signal on a respective one of the plurality of event signal outputs to indicate progress of execution of a task by the module.

7. The digital system of claim 6, wherein the functional module comprises circuitry configured to produce a plurality of control signals while executing a task, wherein the functional module has a set of event signal outputs corresponding to a portion of the control signals.

8. The digital system of claim 7, wherein the functional module further comprises event generation circuitry coupled to receive the portion of control signals, wherein the event generation circuitry is configured to assert an event signal pulse on an event signal output each time a corresponding one of the control signals is asserted.

9. A method for monitoring a system on a chip, comprising:
executing a software program within the system on a chip (SOC);
initiating autonomous micro-task execution by a number of coupled functional modules within the SOC in response to execution of the software program;
detecting a plurality of events within each of the functional units indicative of progression of micro-task execution within each functional unit; and
capturing the plurality of events detected by each of the functional modules within a module located within the SOC.

10. The method of claim 9, further comprising triggering a capture window, wherein the capture of the plurality of events occurs only during the capture window.

11. The method of claim 9, further comprising enabling only a selected portion of the plurality of events to be captured.

12. The method of claim 9, further comprising recording one or more software messages initiated by the software program, wherein the recorded software messages are interleaved with the captured plurality of events.

13. The method of claim 9, further comprising attaching a time stamp to the captured plurality of events.

14. The method of claim 9, further comprising:
reporting the captured plurality of events to an external test system; and
correlating the sequence of captured events to the execution of the software program.

15. The method of claim 14, wherein the sequence of captured events is reported using a common interface port connected to the SOC.
